(19) United States
(12) Patent Application Publication
(10) Pub. No.: US 2013/0106807 A1
(43) Pub. Date: May 2, 2013

(54) Three-dimensional Image Switching Device and Three-dimensional Image Display Device Thereof

(71) Applicants: Chun-Ming Lin, Hsin-Chu (TW); Wen-Chung Chuang, Hsin-Chu (TW); Po-Fu Huang, Hsin-Chu (TW)

(72) Inventors: Chun-Ming Lin, Hsin-Chu (TW); Wen-Chung Chuang, Hsin-Chu (TW); Po-Fu Huang, Hsin-Chu (TW)

(73) Assignee: AU OPTRONICS CORPORATION, Hsin-Chu (TW)

(21) Appl. No.: 13/613,045

(22) Filed: Sep. 13, 2012

(30) Foreign Application Priority Data
Oct. 28, 2011 (TW) 100139577

(51) Int. Cl. G06F 3/038

(52) U.S. Cl. 345/204

(57) ABSTRACT

A three-dimensional switching device includes an image switching panel, at least a first and a second driver unit, and at least a signal connection circuit. The image switching panel has a plurality of first electrodes criss-crossing with a plurality of second electrodes. The first driver unit has a first flexible circuit board with a first driver circuit disposed thereon that connects to a side of the image switching panel, and has a first output terminal electrically connected to the first electrodes. The second driver unit similarly has a second flexible circuit board having a second driver circuit connecting to the other side of the image switching panel with a second output terminal electrically connected to the second electrodes. The signal connection circuit connects to the image switching panel. The first and second driver circuits respectively have a first and second input terminal electrically connected to the signal connection circuit.

### BACKGROUND OF THE INVENTION

1. Field of the Invention

The present invention generally relates to a three-dimensional image switching device. Particularly, the present invention relates to a three-dimensional image switching device for use in a three-dimensional image display device.

2. Description of the Prior Art

Liquid crystal display devices, such as liquid crystal display televisions, are electronic image display products that are currently in wide use by the general public. In order to satiate the public's ever increasing demand for these electronic products, the display dimensions of liquid crystal display devices have gradually increased over the years. However, mere increases in display dimension only are insufficient in satisfying the public's needs. Accordingly therefore, many liquid crystal display device manufacturers have introduced three-dimensional display devices, with their display dimensions becoming a key factor in determining the success or failure of the product.

FIG. 1A illustrates a conventional three-dimensional liquid crystal display device 10. FIG. 1B is a side view of FIG. 1A. The three-dimensional liquid crystal display device 10 includes a controller unit 1, a display panel connection circuit 2, a flexible circuit 3, a three-dimensional image switching module 5, and a display panel 8. As shown in FIGS. 1A and 1B, the three-dimensional image switching module 5 includes a plurality of controller circuits 6 and a display area 7. As shown in FIG. 1B, the dimensions of the display area 7 corresponds to the projection area on the display panel. In the conventional three-dimensional image switching module 5, the controller circuit 6 utilizes Chip-on-Glass (ie. COG) technology to combine with the glass substrate of the three-dimensional image switching module 5. The controller circuit 6 is then electrically connected to the controller unit 1 through the flexible circuit 3. The controller unit 1 primarily transmits image signals to the display panel 8 through the display panel connection circuit 2. At the same time, the controller unit 1 may control the plurality of controller circuits 6 such that the display areas 7 controlled by the controller circuits 6 may switch between normal two-dimensional or three-dimensional display modes.

However, as the dimension of the three-dimensional display device increases, after a certain point the length of the three-dimensional display device will be too long and cause the surface of the entire display panel to be curved. Under these circumstances, during the COG manufacturing process, faulty electrical connections will usually form at the circuit connections between the controller circuits 6 and the three-dimensional display panel. Therefore, problems will occur with the three-dimensional image switching module 5 as a result of signals not being able to be efficiently transmitted to the controller circuits 6 by the panel, and consequently affecting the quality of the image display.

In addition, as the dimension of the display panel 8 increases, the length of the electrical lines between the controller unit 1 and the individual controller circuits 6 in the three-dimensional image switching module 5 will also increase. Since resistance by the electrical lines to the signals transmitting from the controller unit 1 to the controller circuits 6 will affect the quality of the signals, in normal circumstances the width of the electrical lines would be increased as the length increases so that the same level of signal quality may be maintained. However, in consideration of product designs in terms of aesthetics, the enlargement of the space for electrical lines on the display panel outside the display area 7 is typically not allowed, which consequently means that increasing the width of the electrical lines is no easy task and poses a difficult hurdle for the entire design.

### SUMMARY OF THE INVENTION

It is an object of the present invention to provide a three-dimensional image switching device that can increase the quality of control signal transmissions.

It is another object of the present invention to provide a three-dimensional image switching device, for use in a three-dimensional image display device that has better image display and three-dimensional switching effects.

The present invention provides a three-dimensional image switching device and a three-dimensional image display device including the three-dimensional image switching device. The three-dimensional image switching device includes an image switching panel, at least a first driver unit, at least a second driver unit, and at least a signal connection circuit. The image switching panel includes a first electrode substrate, a second electrode substrate, and a liquid crystal layer between the first and second electrode substrate. The first electrode substrate has a plurality of first electrodes, while the second electrode substrate has a plurality of second electrodes. The plurality of first electrodes criss-crosses with the plurality of second electrodes. The first driver unit includes a first flexible circuit board connected to a side of the image switching panel, and a first driver circuit disposed on the first flexible circuit board, wherein the first driver circuit has a first output terminal electrically connected to the first electrodes. The second driver unit includes a second flexible circuit board connected to another side of the image switching panel, and a second driver circuit disposed on the second flexible circuit board, wherein the second driver circuit has a second output terminal electrically connected to the second electrodes. The signal connection circuit is connected to the image switching panel, wherein the first driver circuit has a first input terminal and the second driver circuit has a second input terminal, and the first input terminal and the second input terminal are separately electrically connected to the signal connection circuit. Each signal connection circuit may be disposed among first and second driver units that are adjacent to each other, wherein the signal connection circuit is disposed on at least a side of each the first and second driver units. The viewable area on the image switching panel of the image switching device may be divided into a plurality of blocks. Each block may be controlled by different combinations of first driver units and second driver units, wherein the source of the control signal of each block may be separately received by different signal connection circuits. The image switching device may further includes a first electrode connection circuit and a second electrode connection circuit, wherein the first electrode connection circuit is disposed outside the image switching panel and electrically connects the first driver unit that is not adjacent to the signal connection circuit to the first driver unit that is adjacent to the signal connection circuit, and then electrically connects to the signal connection circuit. The second electrode connection circuit is disposed outside the image switching panel and electrically connects the second driver unit that is not adjacent to the signal connection circuit to the second driver unit that is adjacent to the signal connection circuit, and then electrically connects to the signal connection circuit.

### BRIEF DESCRIPTION OF THE DRAWINGS

FIGS. 1A and 1B are a top and side view of a conventional three-dimensional liquid crystal display;

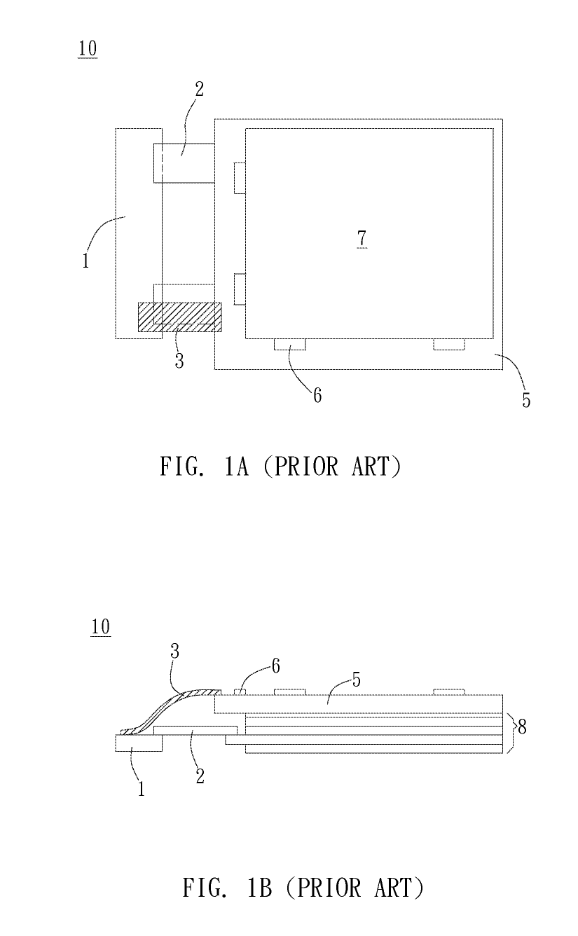

FIG. 2A is a view of an embodiment of the three-dimensional image display device of the present invention;

FIG. 2B is a top view of FIG. 2A;

FIG. 2C is a top view of another embodiment of FIG. 2B;

FIG. 3A is a cross-sectional view of an embodiment of the image switching panel and display panel;

FIG. 3B is a top view of FIG. 3A;

FIG. 4A is another embodiment of FIG. 2A;

FIG. 4B is a top view of FIG. 4A; and

FIG. 4C is a top view of another embodiment of FIG. 4B.

### DETAILED DESCRIPTION OF THE PREFERRED EMBODIMENT

A three-dimensional image switching device and a three-dimensional image display device including the three-dimensional image switching device are provided.

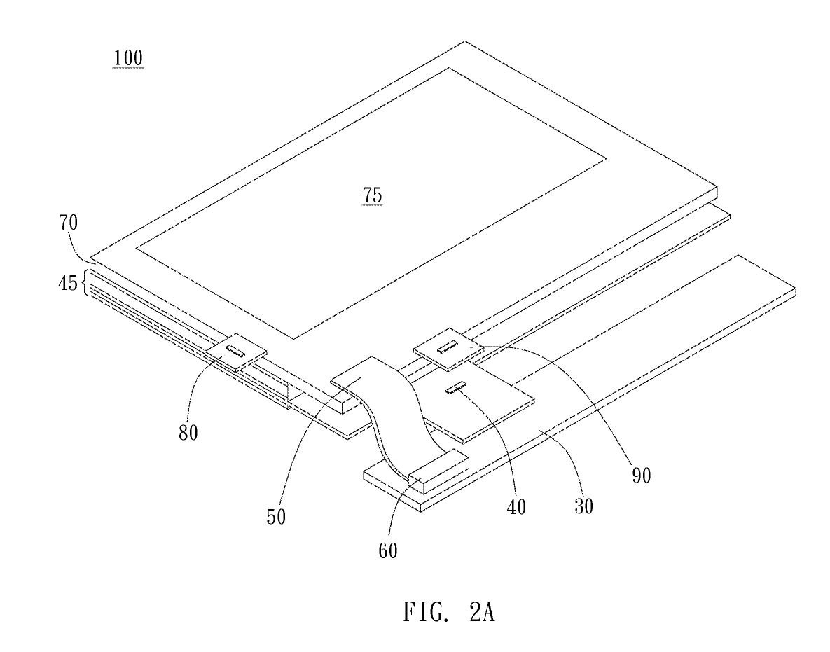

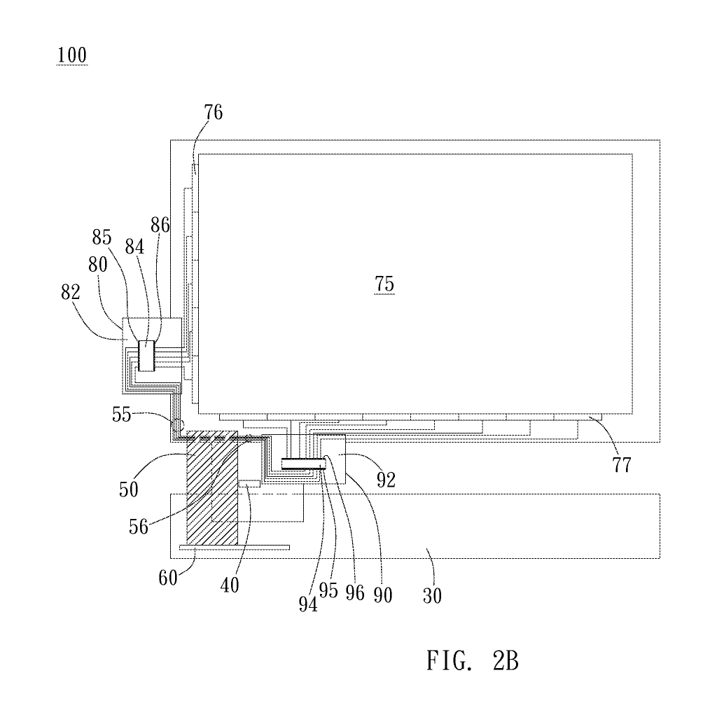

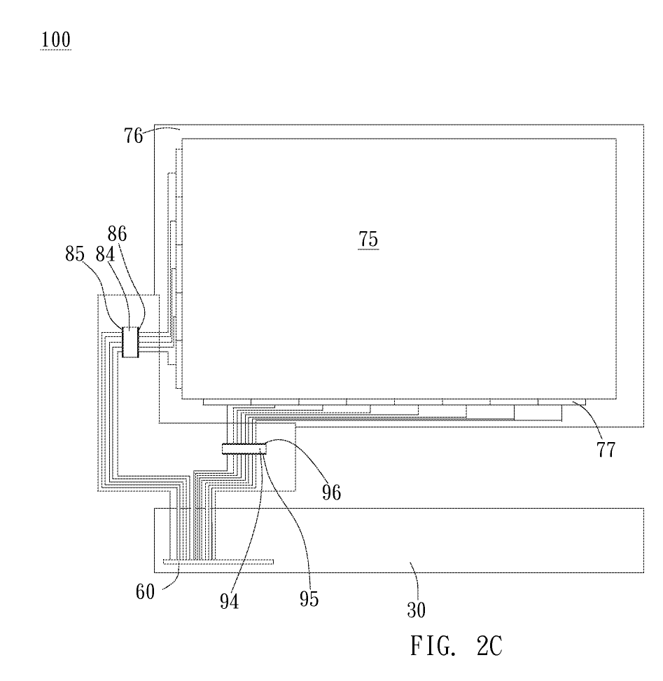

FIG. 2A illustrates an embodiment of a three-dimensional image display device 100 of the present invention. As shown in FIG. 2A, the three-dimensional image display device 100 includes a three-dimensional image switching device 70, a display panel 45, at least one image driver circuit 40, and a signal source circuit board 30. Signal source circuit board 30 is electrically connected to the display panel 45 through the image driver circuit 40 so that the signal source circuit board 30 can control the image display of the display panel 45. In the present embodiment, the display panel 45 is a thin film transistor liquid crystal display panel (TFT-LCD panel), while the signal source circuit board 30 is a printed circuit board (PCB). The image driver circuit 40 is a circuit based on chip-on-film (COF) manufacturing technology. However, in other different embodiments, the image driver circuit 40 may also employ chip-on-glass (COG) technology to be directly disposed on the display panel 45, and then is connected to the signal source circuit board 30 through a flexible printed circuit board. As shown in FIG. 2A, the image driver circuit 40 is connected to the display panel 45 and the signal source circuit board 30 through a flexible printed circuit board.

As shown in FIG. 2A, the three-dimensional image switching device 70 is stacked correspondingly with the display panel 45 and includes an image switching panel 75, a first driver unit 80, a second driver unit 90, and a signal connection circuit 50. In the present embodiment, the second driver unit 90 is connected on the image switching panel 75 on a side facing the signal source circuit board 50. In a preferred embodiment, the signal connection circuit 50 is disposed between the first driver unit 80 and the second driver unit 90, wherein the position that the signal connection circuit 50 is disposed at is preferably at a corner of the image switching panel 75 so that the length of electrical lines may be evenly distributed while also decreasing signal resistance by decreasing the overall lengths of each electrical line. The signal connection circuit 50 is preferably formed from a flexible printed circuit board, wherein the signal connection circuit 50 may be disposed on the three-dimensional switching device 70 positioned on a same side as the first driver unit 80 or the second driver unit 90. For instance, the signal connection circuit 50 of FIG. 2A is disposed on the same side as the second driver unit 90 on the three-dimensional image switching device 70. However, in other different embodiments, the signal connection circuit 50 may also be disposed on the same side as the first driver unit 80 on the three-dimensional image switching device 70. As shown in FIG. 2A, the signal source circuit board 30 has a connection device 60 electrically connected to the signal connection circuit 50. The signal source circuit board 30 can transmit signals to control the three-dimensional image switching device 70 through the connection device 60 and the signal connection circuit 50.

FIG. 2B is a top view of the embodiment of FIG. 2A. As shown in FIG. 2B, the image switching panel 75 has a plurality of first electrodes 76 and a plurality of second electrodes 77, wherein the projection of the plurality of first electrodes 76 onto the plurality of second electrodes 77 criss-crosses with the plurality of second electrodes 77. In a preferred embodiment, the first electrodes 76 and the second electrodes 77 of the image switching panel 75 are separately controlled by the first driver unit 80 and the second driver unit 90. In other words, the first driver unit 80 controls the first electrodes 76, while the second driver unit 90 controls the second electrodes 77. The first driver unit 80 and the second driver unit 90 are preferably manufactured with COF technology. As shown in FIG. 2B, the first driver unit 80 includes a first flexible circuit board 82 and a first driver circuit 84. The first driver circuit 84 has a first input terminal 85 and a first output terminal 86. In the present embodiment, the first input terminal 85 is electrically connected to the signal connection circuit 50 through a circuit 55 on the three-dimensional image switching device 70. Whereas, the first output terminal 86 is respectively connected electrically to each first electrode 76. In the present embodiment, the first driver unit 80 is preferably disposed near the signal connection circuit 50 in order to simplify the circuit layout on the image switching panel 75. In other words, as shown in FIG. 2B, if the position that the first driver unit 80 was disposed at is shifted to a position in closer proximity to the signal connection circuit 50, the circuit 55 would be able to be shortened to prevent the circumstance where the circuit 55 is disposed in parallel to and fighting for the same space as the electrical lines connecting each of the first electrodes 76 to the first driver unit. In other words, as shown in FIG. 2B, since the first driver unit 80 is disposed relatively close to the signal connection circuit 50, the circuit 55 is disposed on the image switching panel 75 but does not have to share the same space as the electrical lines connecting the first electrodes 76 to the first driver unit 80. Through this design, the signal source circuit board 30 of the three-dimensional image display device 100 may drive and control the plurality of first electrodes 76 of the image switching panel 75 through the signal connection circuit 50 and the first driver circuit 84 of the first driver unit 80. As shown in FIG. 2B, the second driver unit 90 includes a second flexible circuit board 92 and a second driver circuit 94. Similar to first driver unit 80, the second driver circuit 94 has a second input terminal 95 and a second output terminal 96, wherein the second input terminal 95 is electrically connected to the signal connection circuit 50 through the circuit 56. The second output terminal 96 is separately electrically connected to each of the second electrodes 77 of the image switching panel 75.

FIG. 2C is another embodiment of FIG. 2B. As shown in FIG. 2C, the first driver unit 80 and the second driver unit 90 are disposed on the same flexible printed circuit board, wherein the combined entity of the flexible printed circuit board with the first and second driver units is preferably disposed at a corner of the three-dimensional image switching device 70 adjacent to the signal source circuit board 30. In other words, in the present embodiment, the first and second flexible printed circuit boards are grouped together to form a single flexible printed circuit board 32 that holds the first driver circuit 80 and the second driver circuit 90. In this instance, the signal connection circuit 50 that was used to provide a connection for the signal source circuit board 30 to connect to the first and second driver units may be replaced by electrical lines (circuit paths) that are formed directly on the same flexible circuit board. This design allows greater circuit line widths to lower the resistance levels without being affected by the space constraints on the image switching panel 75.

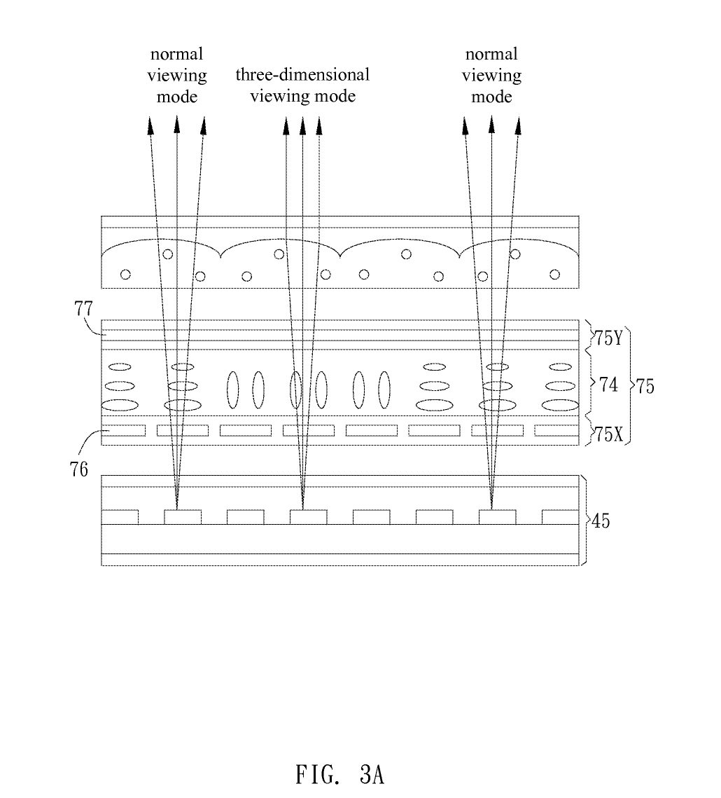

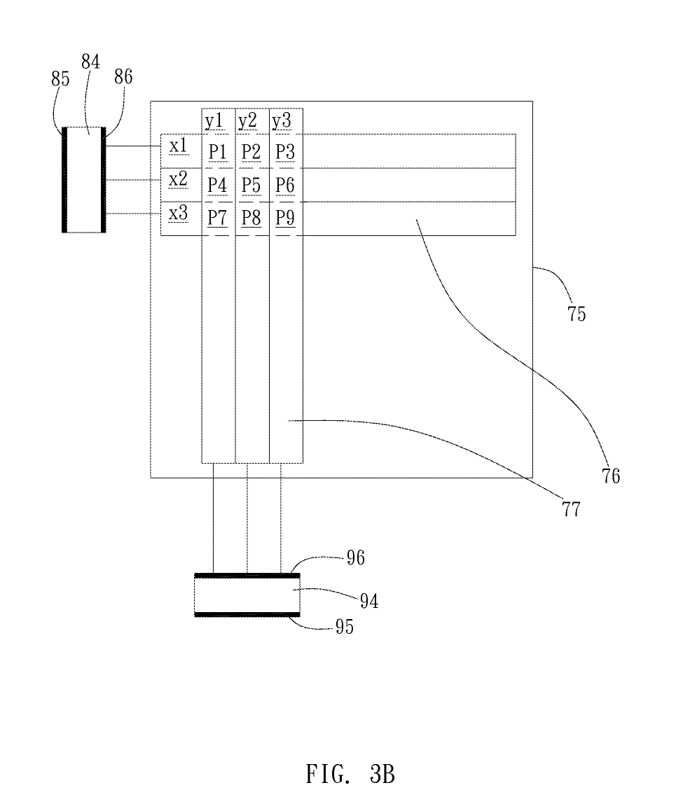

The following descriptions will detail the structure and the mode of operation of the image switching panel 75 through FIGS. 3A and 3B. FIG. 3A is a cross-sectional view of the image switching panel 75 and the display panel 45. FIG. 3 is a simplified top view of the image switching panel 75 of FIG. 3A.

As shown in FIGS. 3A and 3B, the image switching panel 75 is disposed on the display panel 45, wherein the image switching panel 75 is composed of upper and lower substrates of a first electrode substrate 75X and a second electrode substrate 75Y. A liquid crystal layer 74 is disposed between the first electrode substrate 75X and the second electrode substrate 75Y. In the present embodiment, a plurality of first electrodes 76 are disposed on the first electrode substrate 75X, while a plurality of second electrodes 77 are disposed on the second electrode substrate 75Y. In the present embodiment, the liquid crystal layer 74 of the image switching panel 75 can affect and change the direction of image light from the display panel 45.

FIG. 3B is a top view of FIG. 3A. As shown in FIG. 3B, in the present embodiment, the first electrode substrate 75X of the image switching panel 75 includes the plurality of first electrodes 76 of FIGS. 2B-2C. The second electrode substrate 75Y includes the plurality of second electrodes 77. In the present figure, only three electrodes each of the first electrode substrate 75X and the second electrode substrate 75Y are shown for simplicity purposes. However, it should be noted that the present invention is not restricted to this amount.

As shown in FIG. 3B, the first electrode substrate 75X is correspondingly stacked with the second electrode substrate 75Y. In the present embodiment, the plurality of first electrodes 76 of the first electrode substrate 75X are labeled as electrodes x1 to x3, wherein each electrode is respectively connected electrically to the first driver unit 80 through the first driver circuit 84. The plurality of second electrodes 77 of the second electrode substrate 75Y are labeled electrodes y1 to y3, wherein each electrode is respectively connected electrically to the second driver unit 90 through the second driver circuit 94. As shown in FIGS. 3A and 3B, the projection of the electrodes x1 to x3 onto the electrodes y1 to y3 criss-crosses with electrodes y1 to y3, wherein nine intersection points P1 to P9 may be seen. In practice, each intersection point P1 to P9 represents a pixel on the three-dimensional image display device 100. In the present embodiment, each pixel point P1 to P9 may be freely switched into normal display mode or three-dimensional display mode by signals from the signal source circuit board 30. In other words, the signal source circuit board 30 may transmit signals to one of the electrodes x1 to x3 through the forms mentioned in FIGS. 2A to 2C. Simultaneously, the signal source circuit board 30 may also transmit signals to one of the electrodes y1 to y3. When the first electrode (ie. one of the electrodes x1 to x3) and the second electrode (ie. one of the electrodes y1 to y3) are driven by the signal source circuit board 30, the intersection point of the first and second electrodes will be driven, causing the liquid crystal of the liquid crystal layer 74 (as shown in FIG. 3A) at that particular intersection point to change its arrangement or orientation direction. This change in arrangement or orientation direction of the liquid crystal at the intersection point results in the pixel that represents that intersection point to switch from normal display mode to three-dimensional display mode. For instance, the signal source circuit board 30 can switch the pixel point P5 to three-dimensional image display mode through driving the electrodes x2 and y2. When the pixel point P5 is switched to the three-dimensional image display mode, the direction of light from the display panel 45 will change (as shown in FIG. 3A) according to the change in arrangement or orientation direction of the liquid crystal. Therefore, through the use of the first driver unit 80 and the second driver unit 90 to control each first electrodes 76 and each second electrodes 77 in conjunction with the optical layer disposed on the image switching panel 75 (refer to the optical layer on top of the image switching panel 75 in FIG. 3A), the signal source circuit board 30 can control the display mode (normal or three-dimensional image display mode) of every pixel point on the image switching panel 75.

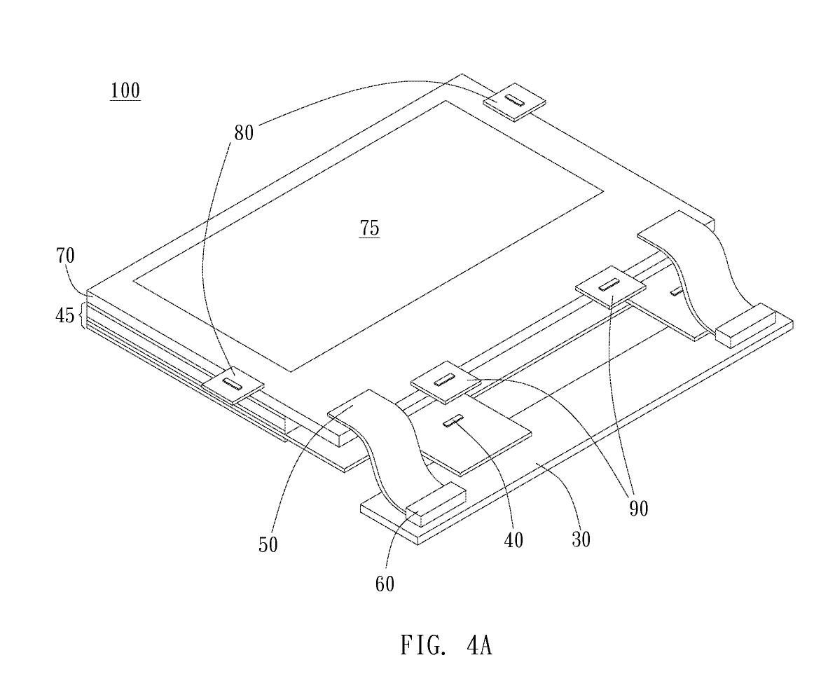

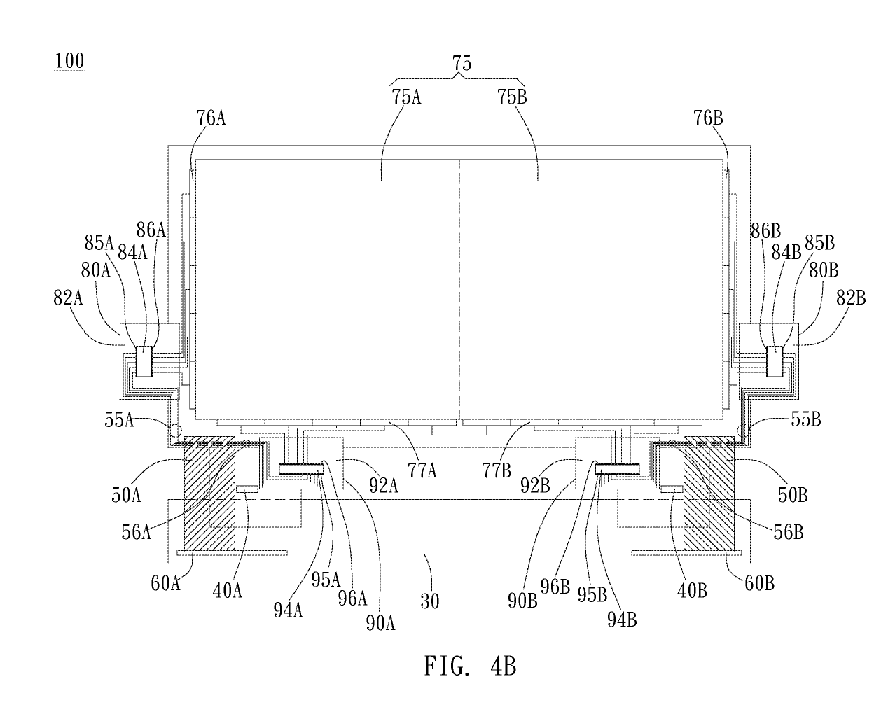

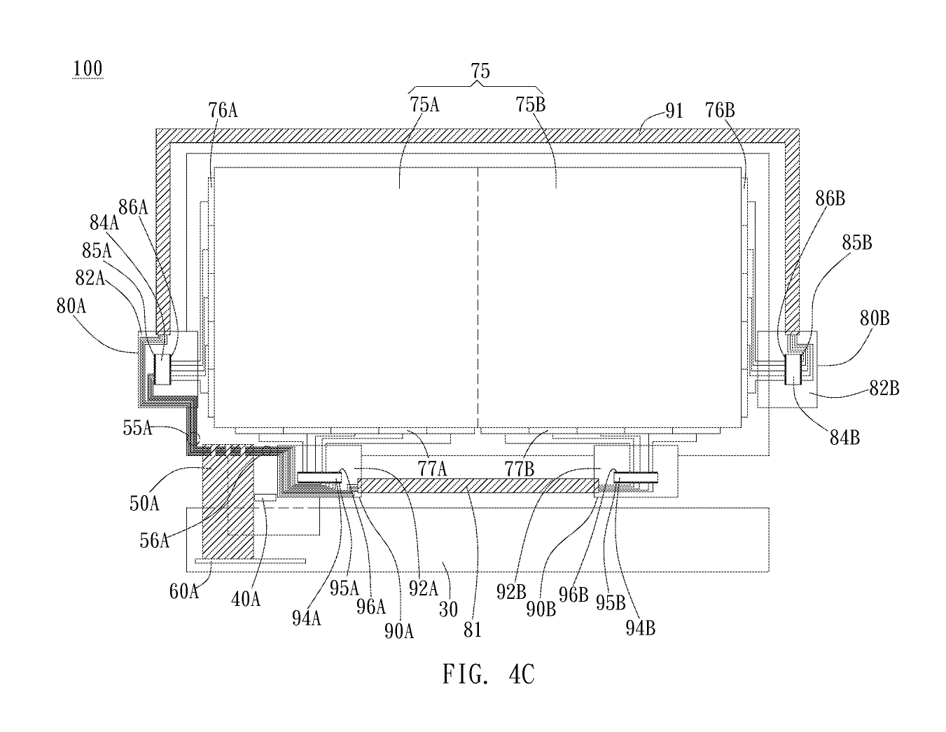

FIGS. 4A and 4B are another embodiment of FIG. 2A. FIG. 4A is a three-dimensional view while FIG. 4B is a top view schematic diagram. As shown in FIG. 4A, the three-dimensional image switching device 70 has two first driver units 80, two second driver units 90, and two signal connection circuits 50. The two first driver units 80 are separately connected to the image switching panel 75 on opposite sides of the image switching panel 75. As shown in FIG. 4A, the second driver unit 90 is connected to a side of the image switching panel 75 facing the signal source circuit board 30 that is not the two sides that the first driver units 80 are located. In a preferred embodiment, a signal connection circuit 50 is disposed between each first driver unit 80 and second driver unit 90 that are adjacent to each other, wherein the signal connection circuit 50 is preferably disposed at a corner of the image switching panel 75 such that the length of the electrical lines (circuit paths) and the resistance thereof may be more evenly distributed.

Through the above mentioned design, the problem of placing too many circuit lines on one side of the image switching panel may be resolved. In other words, when the surface area of the viewable area of the image switching panel 75 increases, the amount of first electrodes 76 and second electrodes 77 will correspondingly increase as well. This conversely means that the amount of circuit lines between the first and second electrodes (76, 77) and the first and second driver units (80, 90) will also substantially increase. In addition, since the viewable area increased in dimension, there will be many first electrodes 76 and second electrodes 77 that will be positioned further away from the signal connection circuit 50. When the circuit lines become longer in length, signal quality will decrease from resistance by the circuit line during the signal transmission. Under constraints of maintaining the overall design and aesthetics of the display device, it is relatively difficult to increase the width of the circuit lines in order to increase the signal quality as there is limited space for the installation of circuit lines on the image switching panel 75. As such, the circuit lines cannot all be effectively concentrated on a same side of the image switching panel 75. In order to solve these difficulties, an embodiment shown in FIG. 4B utilizes a plurality of signal connection circuits 50 to transmit signals from the signal source circuit board 30 to each first electrode 76 and second electrode 77 such that the circuit line positions may be dispersedly distributed while also decreasing the distance between each first electrode 76 and second electrode 77. In addition, the plurality of the first driver units and the plurality of the second driver units of the present embodiment utilize COF technology to be disposed on the image switching panel 75. Through this design, the problem of faulty connections between the first and second driver units with the image switching panel 75, which arises from the use of COG technology to dispose the first and second driver units on an overly large dimensioned image switching panel 75 that has a curved surface due to being overly large, may be overcome. In other words, the installation positioning of the first driver unit 80A and the second driver unit 90A may be adjusted according to design requirements, such as in consideration of the distance between each first and second driver units. At the same time, through the use of COF technology, the surface curving of the image switching panel 75 due to the panel being overly long in length need not be worried about.

As shown in FIG. 4B, the viewable area of the image switching panel 75 may be partitioned or divided into block 75A and block 75B according to the signal control area. It should be noted that the viewable area of the image switching panel 75 is not limited to being divided into block 75A and block 75B. Simply, the viewable area of the image switching panel 75 may be divided into a plurality of blocks, wherein each block is controlled by different combinations of the first driver units and the second driver units. In other words, each block has its own plurality of first electrodes 76 and second electrodes 77, wherein these first and second electrodes are controlled by the first and second driver units controlling that particular block. As shown in the embodiment in FIG. 4B, block 75A is controlled by the combination of the first driver unit 80A and the second driver unit 90A. Whereas, the block 75B is controlled by the combination of the first driver unit 80B and the second driver unit 90B. In other words, by changing the installation position or method of the first driver unit and/or the second driver unit, or through increasing the amount of different combinations, the quantity of blocks composing the viewable area of the image switching panel 75 may be increased or decreased. The dimensions of each block of the image switching panel 75 may be adjusted according to design specification requirements. As shown in FIG. 4B, the right half and the left half of the three-dimensional image display device 100 are symmetric. Block 75A is controlled by the first driver unit 80A and the second driver unit 90A, while the block 75B is controlled by the first driver unit 80B and the second driver unit 90B. Through this design, the signal source circuit board 30 may control block 75A and block 75B through the signal connection circuit 50A and the signal connection circuit 50B. The signal source circuit board 30 of the three-dimensional image display device 100 can transmit signals to drive and control block 75A and 75B of the image switching panel 75. In a preferred embodiment, the signal connection circuits 50A and 50B are separately connected to the three-dimensional image switching device 70 at opposite ends of the signal source circuit board 30. The purpose of this design is to allow the signal source circuit board 30 to transmit signals to the first electrode 76A, first electrode 76B, second electrode 77A, and the second electrode 77B of the of the image switching panel 75 over a shorter circuit line distance.

FIG. 4C is another preferred embodiment of FIG. 4B. In the present embodiment, a plurality of first and second driver units are electrically connected to the signal source circuit board 30 through a signal connection circuit 50A. As shown in FIG. 4C, the first driver unit 80A and the second driver unit 90A are still electrically connected with the signal connection circuit 50A through the circuit line 55. The difference in the present embodiment lies in that the three-dimensional image switching device 70 has a first electrode connection circuit 91 and a second electrode connection circuit 81. As mentioned above, since there is limited space available for installation of the circuit lines on the image switching panel 75, the circuit lines on the image switching panel 75 may not be increased in width in order to increase the signal quality to solve the problem of increased resistance when increasing the circuit line lengths. Accordingly, one of the design challenges is to figure out how to effectively and efficiently transmit signals to each of the first and second electrodes. Therefore, in the present embodiment, in order to overcome the problems of limited space and decreasing signal quality, the first electrode connection circuit 91 and the second electrode connection circuit 81 are disposed outside the image switching panel 75. In this manner, the overall resistance levels may be decreased while increasing the flexibility of the distribution of the circuit lines. The first electrode connection circuit 91 and the second electrode connection circuit 81 are preferably flexible printed circuit boards. However, the first electrode connection circuit 91 and the second electrode connection circuit 81 are not limited to being flexible printed circuit boards. Through this design, the width of the circuit lines of the first electrode connection circuit 91 and the second electrode connection circuit 81 may be increased to prevent or reduce the phenomenon of decreased signal quality from occurring. As shown in FIG. 4C, the first electrode connection circuit 91 is distributed above and outside the image switching panel 75, or overlapping with the image switching panel 75 on the portions outside the viewable area of the image switching panel 75. The first electrode connection circuit 91 connects the first driver unit 80B to the first driver unit 80A. The second electrode connection circuit 81 is distributed below and outside the image switching panel 75 and connects the second driver unit 90B to the second driver unit 90A. In this manner, the signal source circuit board 30 can transmit signals to the first driver units 80A and 80B, as well as to the second driver units 90A and 90B, through the signal connection circuit 50A.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A three-dimensional image switching device, comprising:
an image switching panel having a plurality of first electrodes criss-crossing with a plurality of second electrodes;
at least a first driver unit comprising a first flexible circuit board connected to a side of the image switching panel, and a first driver circuit disposed on the first flexible circuit board, wherein the first driver circuit has a first output terminal electrically connected to the first electrodes;
at least a second driver unit comprising a second flexible circuit board connected to the other side of the image switching panel, and a second driver circuit disposed on the second flexible circuit board, wherein the second driver circuit has a second output terminal electrically connected to the second electrodes; and
at least a signal connection circuit connected to the image switching panel;
wherein the first driver circuit has a first input terminal and the second driver circuit has a second input terminal, the first input terminal and the second input terminal respectively are electrically connected to the signal connection circuit.

2. The three-dimensional image switching device of claim 1, wherein the first input terminal and the second input terminal respectively are electrically connected to a circuit on the image switching panel, and electrically connected to the signal connection circuit through the circuit on the image switching panel.

3. The three-dimensional image switching device of claim 1, wherein each of the signal connection circuits is disposed between adjacent first driver units and second driver units.

4. The three-dimensional image switching device of claim 3, wherein the signal connection circuit is disposed on at least a side of each of the first driver units and second driver units.

5. The three-dimensional image switching device of claim 3, further comprising a second electrode connection circuit disposed outside the image switching panel and electrically connecting the second driver unit non-adjacent to the signal connection circuit to the second driver unit adjacent to the signal connection circuit and then connecting to the signal connection circuit.

6. The three-dimensional image switching device of claim 3, further comprising a first electrode connection circuit disposed outside the image switching panel and electrically connecting the first driver unit non-adjacent to the signal connection circuit to the first driver unit adjacent to the signal connection circuit and then electrically connecting to the signal connection circuit.

7. The three-dimensional image switching device of claim 3, wherein a viewable area on the image switching panel is divided into a plurality of blocks, each block is controlled by different combinations of the first driver units and the second driver units.

8. The three-dimensional image switching device of claim 7, wherein a control signal source is received by each block from different signal connection circuits.

9. The three-dimensional image display device, comprising:
the three-dimensional image switching device of claim 1;
a display panel correspondingly stacked with the three-dimensional image switching device;
at least an image driver circuit electrically connected to the display panel to control an image display of the display panel; and
a signal source circuit board electrically connected with the image driver circuit, wherein the signal source circuit board has a connection device electrically connected to the signal connection circuit.

10. The three-dimensional image display device of claim 9, wherein the first input terminal and the second input terminal respectively are electrically connected to a circuit on the image switching panel, and electrically connected to the signal connection circuit through the circuit on the image switching panel.

11. The three-dimensional image display device of claim 9, wherein each of the signal connection circuits is disposed between adjacent first driver units and second driver units.

12. The three-dimensional image display device of claim 11, wherein the signal connection circuit is disposed on at least a side of each of the first driver units and second driver units.

13. The three-dimensional image display device of claim 11, further comprising a second electrode connection circuit disposed outside the image switching panel and electrically connecting the second driver unit non-adjacent to the signal connection circuit to the second driver unit adjacent to the signal connection circuit and then connecting to the signal connection circuit.

14. The three-dimensional image display device of claim 11, further comprising a first electrode connection circuit disposed outside the image switching panel and electrically connecting the first driver unit non-adjacent to the signal connection circuit to the first driver unit adjacent to the signal connection circuit and then electrically connecting to the signal connection circuit.

15. The three-dimensional image display device of claim 11, wherein a viewable area on the image switching panel is divided into a plurality of blocks, each block is controlled by different combinations of the first driver units and the second driver units.

16. The three-dimensional image display device of claim 15, wherein a control signal source is received by each block from different signal connection circuits.
